(19) United States
(12) Patent Application Publication
(10) Pub. No.: US 2008/0022115 A1
(43) Pub. Date: Jan. 24, 2008

(54) METHOD AND SYSTEM FOR ELECTRONIC GRAFFITI

(75) Inventors: VON A. MOCK, BOYNTON BEACH, FL (US); DAVID J. HAYES, LAKE WORTH, FL (US); JORGE L. PERDOMO, BOCA RATON, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/421,252

(22) Filed: May 31, 2006

(51) Int. Cl. H04L 9/00

(52) U.S. Cl. 713/178

(57) ABSTRACT

A system (100) and method (800) for electronic graffiti includes a plurality of graffiti nodes serving as a plurality of wireless access points 102, a server 103 coupled to the plurality of wireless access points, a mobile wireless device (101 or 700) having at least a local area transceiver (706) and a processor (702) operatively coupled to the local area transceiver. The processor can be programmed to associate (804) a user friendly name with a media access control (MAC) address, associate (806) the user friendly name and media access control address with a group affiliation and a location, and transmit (808) the user friendly name, MAC address, the group affiliation and the location to the server. The server can be further coupled to a central server. Note, the server stores a record for each graffiti node containing the MAC address, the user friendly name, and the group affiliation.

### FIELD

This invention relates generally to communication systems, and more particularly to a method and system of forming user friendly access points and groups.

### BACKGROUND

Children, teens and adults tend toward group activities where they have a sense of security, impact and belonging. Teens create their own identity to have impact on others around them while seeking out-group relationships with others. A teen will look to physical items as well as behaviors to help create an identity that will allow them to gain acceptance in to the social groups that they deem important to them.

The widespread adoption of WLAN technology has created whole neighborhoods that are equipped with wireless LAN (802.11) access points that allow entire families to access the Internet from within and outside the home. This adoption of wireless technology continues as whole cities provide wireless LAN technology. Although there are many references that describe location technology to locate an individual or to be alerted of one or more individuals that belong to a group based on location event information, none describe social awareness using an Access Point's MAC ID in an electronic graffiti group system.

### SUMMARY

Embodiments in accordance with the present invention can provide a user friendly system of creating and forming graffiti nodes and in some embodiments a simple way to relay messages to a member of a predetermined social group when that member comes within range of the node and the node recognizes a media access control address or MAC ID. Embodiments herein enable a teen, family member or group to create electronic graffiti on an access point name within a communication system to provide among other things personal and family security. At the same time this capability provides a new way of determining awareness of others including teens and adults to increase data communication across wireless and wire line networks. A graffiti node in this regard can be an access point enabling access and communication in a social networking environment as contemplated herein.

In a first embodiment of the present invention, a method of forming graffiti nodes in a wireless communication system, can include the steps of associating a user friendly name with a media access control address, associating the user friendly name and media access control address with a group affiliation (and optionally a location), and transmitting the user friendly name, media access control address, and the group affiliation (and the optional location) to a central server. A user friendly name can be a name that would be more readily recognizable than a mere MAC address, the group affiliation can be any defined group and include family members, friends, or members sharing a similar interest or any other grouping desired. The method can further include the step of determining if the media access control address has an existing user friendly name or an existing user friendly name associated with the group affiliation. The method can also include creating the user friendly name. The method can further include the step of associating a time stamp with the step of associating the user friendly name with the media access control address. In this regard, a record for each graffiti node can be created including the media access control address, the user friendly name, and the group affiliation. The group affiliation can be confirmed using a password, personal identity number, or biometric information. Note, the method can further forward information regarding a member having the group affiliation to other members having the group affiliation upon the member communicating with a graffiti node.

In a second embodiment of the present invention, a mobile wireless device can include a local area transceiver and a processor coupled to the local area transceiver. The processor can be programmed to associate a user friendly name with a media access control address, associate the user friendly name and media access control address with a group affiliation (and optionally a location), and transmit the user friendly name, media access control address, and the group affiliation (and the optional location) to a central server. The processor can further be programmed to determine if the media access control address has an existing user friendly name associated with the group affiliation or to create the user friendly name or to associate a time stamp with the user friendly name and the media access control address. The mobile wireless device can also include a security device coupled to the processor that can confirm group affiliation for example by using a password, personal identity number, or biometric information. The processor can also forward information regarding a member having the group affiliation to other members having the group affiliation upon the member communicating with a graffiti node. The mobile wireless device can further include a wide area transceiver coupled to the processor. The local area transceiver can be for example a Bluetooth transceiver or an IEEE 802.11 based transceiver and the wide area transceiver can be for example a cellular phone transceiver, a trunked two-way radio transceiver, a two-way data messaging transceiver, or an IEEE 801.16 based transceiver.

In a third embodiment of the present invention, a communication system including a plurality of graffiti nodes can include a plurality of wireless access points forming the graffiti nodes, a server coupled to the plurality of wireless access points, a mobile wireless device having at least a local area transceiver and a processor operatively coupled to the local area transceiver. The processor can be programmed to associate a user friendly name with a media access control address, associate the user friendly name and media access control address with a group affiliation and a location, and transmit the user friendly name, media access control address, the group affiliation and the location to the server. The server can be further coupled to a central server. Note, the server stores a record for each graffiti node containing the media access control address, the user friendly name, and the group affiliation. The communication system can also include a plurality of mobile wireless devices where each of the mobile wireless devices within a given group affiliation and the server have synchronized information with respect to the media access control address and the user friendly name.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of a communication system in accordance with an embodiment of the present invention.

FIG. 2 is a flow chart of a method of creating a node name for a graffiti node in accordance with an embodiment of the present invention.

FIG. 3 is an illustration of a record of a graffiti name and MAC address in accordance with an embodiment of the present invention.

FIG. 4 is an illustration of an access point naming in a neighborhood in accordance with an embodiment of the present invention.

FIG. 5 is an illustration of a MAC address and graffiti name correspondence as defined by group affiliation in accordance with an embodiment of the present invention.

FIG. 6 is an illustration of a screen on a display using friendly names in accordance with an embodiment of the present invention.

FIG. 7 is a mobile device in accordance with an embodiment of the present invention.

FIG. 8 is a flow chart illustrating a method of forming graffiti nodes in a wireless communication system in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Social electronic graffiti provides the ability for individuals within social groups to provide friendly names to access points or location beacons wherever they may exist. The graffiti system can reinforce social group(s) by knowing when individuals within a group are near a “named” graffiti node. An alternate embodiment would allow individuals of authority or responsibility to understand the whereabouts of individuals in their care by being notified of graffiti nodes that they have previously named. Embodiments herein can increase the awareness of individuals within a social networking group or groups and as a result generate more networking traffic. In addition, the group awareness provides a novel approach for personal and family security.

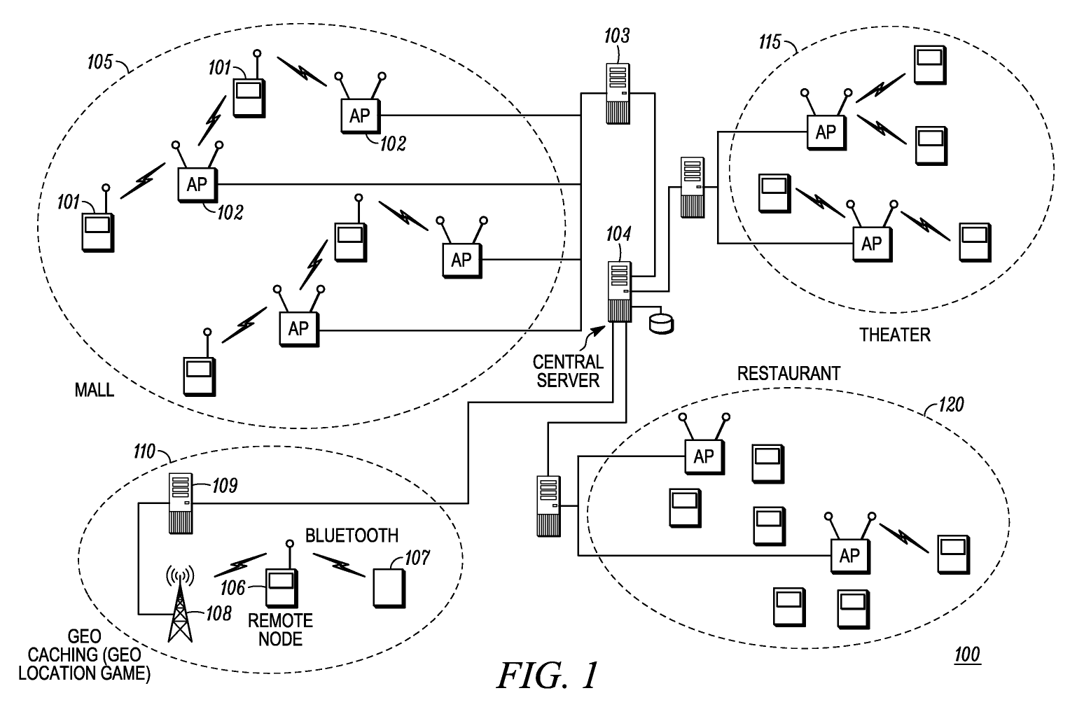

Referring to FIG. 1, a communication system provides the ability for individuals or mobile devices 101 within a social group (such as high school friends that hang out or visit a particular geographical location such as a mall 105, a Geo Caching location 110, a theater 115, or restaurant 120) to provide a preferred name of the location that they visit. The location can be associated with a particular media access control address or MAC ID that is associated with a wireless access point 102. A particular local area network such as the Mall LAN 105 can have multiple wireless access points 102 that are all communicating with a server 103. The servers 103 that are at a particular LAN site can further be coupled to a central server 104.

The mall LAN 105 can include a number of wireless access points that can be named by individuals belonging to one or more social groups. A social group (such as high school band students) can provide a name for the access point or access points and define the social membership for the group. The membership for the social group can be defined in a number of ways including the use of a simple name (e.g., John Doe) or the use of biometric information (e.g., a fingerprint or retinal eye scan done at the mobile device) to authenticate the users belonging to the social group.

In one particular aspect of the invention, the graffiti system central server 104 or a more local server 103 can be notified when an individual belonging to a particular social group (e.g., the “High School Band Group 1”) is near an access point at the mall. This can be accomplished through the user's mobile device capturing the MAC ID of the access point and an application running on the mobile device that contacts the graffiti system server with this information. The process of contacting the graffiti system server (103 or 104) triggers notification to others who are in the individual's social group. This serendipitous event would create voice and/or data traffic over the network as members of the group decide on social interaction.

The access point can also log into a central memory or other memory in an adjacent access point for example and place a geographic reference in the memory in the event of movement of the access point. Such arrangement enables the storage of a history as to where the device was previously resident. This log can allow for retailers, families or businesses which deploy access points to generate change information or a history of what a device was used for or to allow others to seek information related to a particular access point based on a known person or a known location. Users can connect or scan an access point log to verify individuals in common or the place(s) where the access point was previously deployed. Using naming conventions you can also add additional granularity to the classification to locations such as play area, home office, travel office, or generic etc. This would allow users to filter and verify the most popular classification of the access point as well.

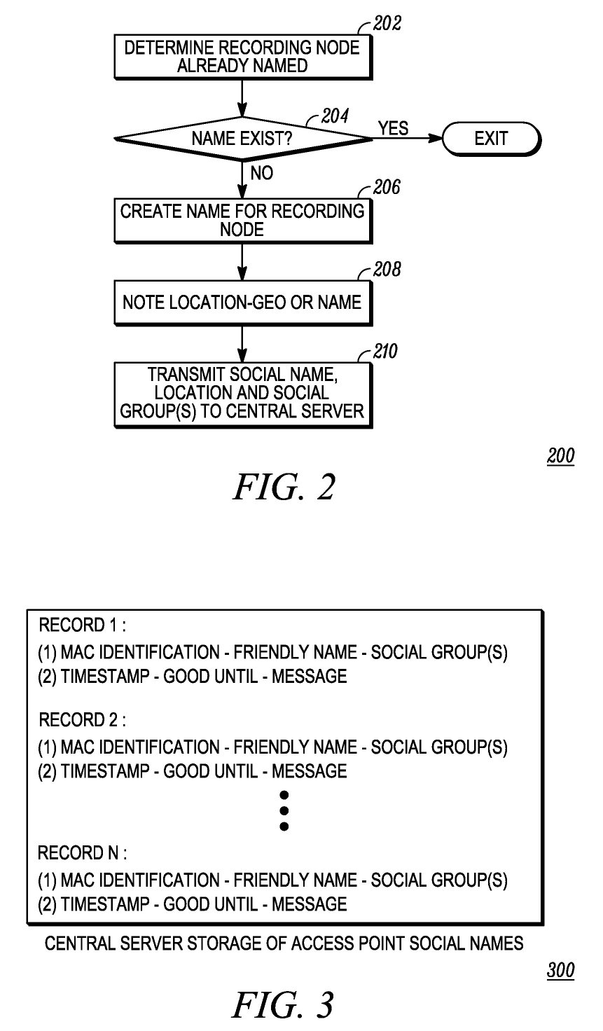

Referring to FIG. 2, a flowchart outlining a method 200 of how an individual of a social group can provide a name for the access point using the MAC ID or address is shown. The MAC ID along with location, timestamp and social name(s) can be provided to the server (103 or 104 of FIG. 1) and can be stored as a series of records 300 as depicted in FIG. 3. At step 202, a determination is made whether a node or access point already has a name (for the particular group). If a name already exists at decision block 204, then the method exits out of the routine. If no name exists for a particular group, then a name can be created at step 206 for the node or access point. Note, the node or access point corresponds to a particular MAC address or ID. The method can also optionally note the particular location at step 208. At step 210, the method 200 can transmit the created node name, affiliated group name (or social group name) as well as the location to a server or a central server coupled to the server.

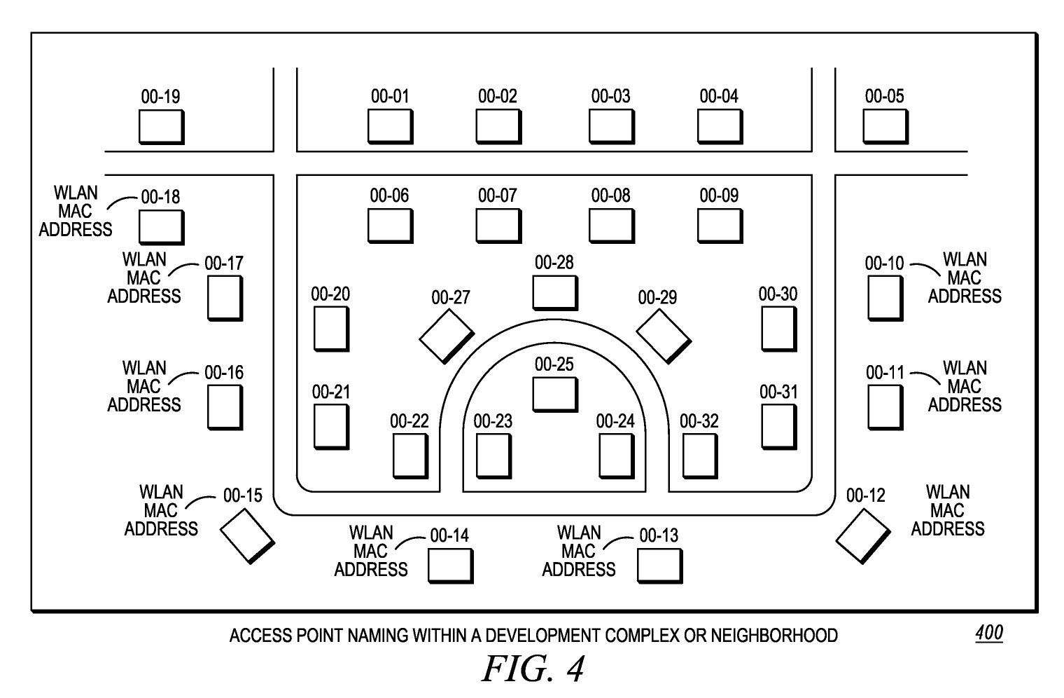

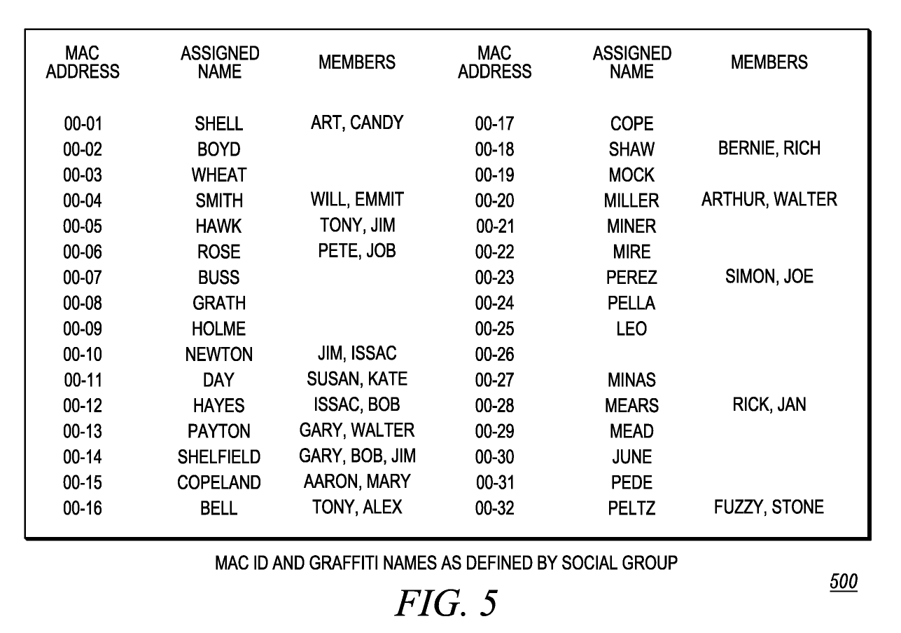

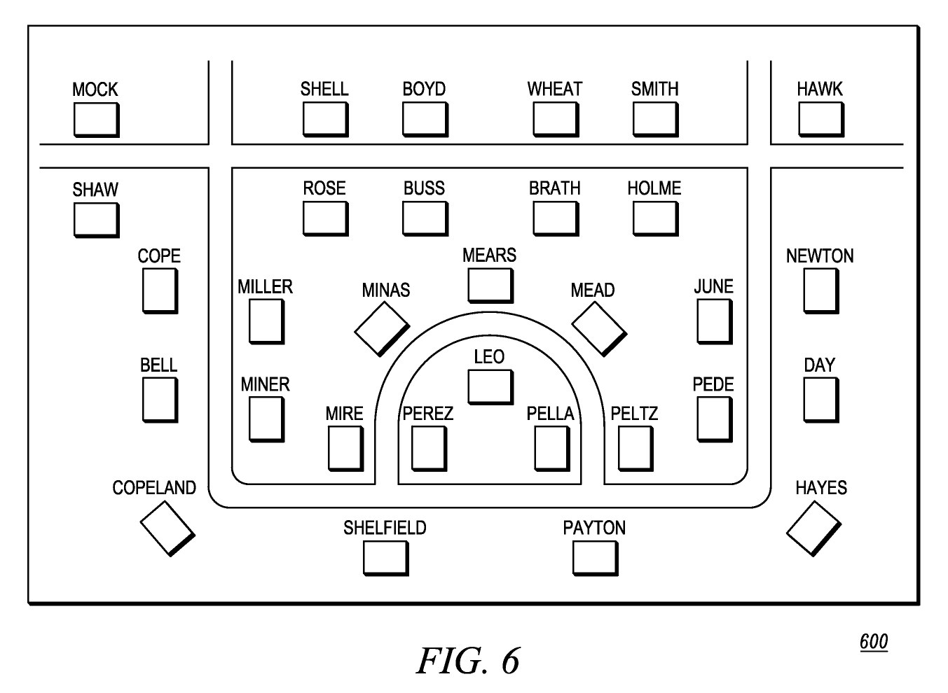

The illustrations of FIGS. 4, 5 & 6 demonstrate an alternate embodiment involving the family household as a social group. The illustration of FIG. 4 shows a typical neighborhood 400 where like most neighborhoods the majority of houses contain wireless local area network access points for personal consumption. As with wireless technology the wireless energy and range extends beyond the house boundaries into the street and surrounding neighborhood. The chart 500 of FIG. 5 shows a list of MAC ID addresses with a corresponding graffiti name created by the parents along with members of the social family group. This closed membership keeps others in the neighborhood from receiving notification including location, but could utilize the names created in their own family social group instances. Referring to FIG. 6, the neighborhood is shown with the new “graffiti names” corresponding to each house. This graffiti naming system enables a family social group to understand the whereabouts of individuals within the group. For example, as kids are walking around the neighborhood the parent receives notification as the kid walks by the Shell's house (see FIG. 6) and continues down the street through Rose, Boyd, Wheat, Buss, Smith, Grath and finally Holme where it appears the kid is visiting with someone in the area.

An alternate method would allow for a device only implementation by having each device in the social group synchronized with the corresponding MAC ID and Graffiti name. Each new record would require the mobile devices within the group to synchronize with this updated information.

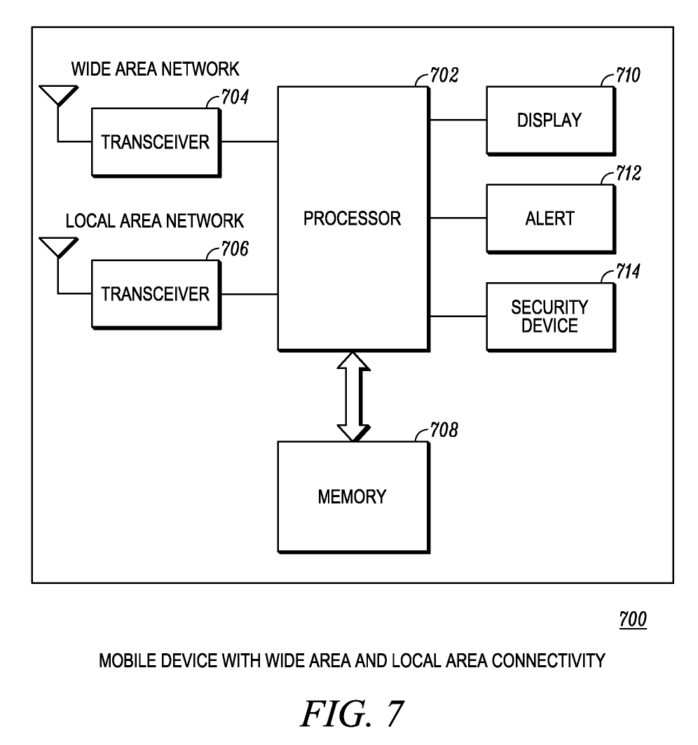

Referring to FIG. 7, a mobile wireless device 700 can include a local area transceiver 706 and a processor 702 coupled to the local area transceiver 706. The processor 702 can be programmed to associate a user friendly name with a media access control address, associate the user friendly name and media access control address with a group affiliation and a location, and transmit the user friendly name, media access control address, the group affiliation and the location to a central server. The processor 702 can further be programmed to determine if the media access control address has an existing user friendly name associated with the group affiliation or to create the user friendly name or to associate a time stamp with the user friendly name and the media access control address. The mobile wireless device 700 can also include a security device 714 coupled to the processor 702 that can confirm group affiliation for example by using a password, personal identity number, or biometric information. The processor 702 can also forward information regarding a member having the group affiliation to other members having the group affiliation upon the member communicating with a graffiti node. The mobile wireless device 700 can further include a wide area transceiver 704 coupled to the processor 702. The local area transceiver 706 can be for example a Bluetooth transceiver or an IEEE 802.11 based transceiver and the wide area transceiver 704 can be for example a cellular phone transceiver, a trunked two-way radio transceiver, a two-way data messaging transceiver, or an IEEE 801.16 based transceiver. Of course, the local and wide area transceivers are not limited to those mentioned above. Embodiments herein can also use any number of other transceivers such as personal area network transceivers or peer-to-peer transceiver such as Motorola's MotoTalk Off-Network Digital Walkie-Talkie feature. This feature creates a temporary short-range virtual network with other Mototalk capable units that keep users connected if the network is down or the signal is weak. The feature also allows for communication in out-of-(network) coverage areas by allowing them to manually transfer to a simplex two-way radio-to-radio communication. MOTOtalk™ is a Push-to-Talk-based feature that operates like most any two-way radio. The mobile wireless device can further include a memory 708, a display 710 and an alerting device 712 coupled to the processor 702.

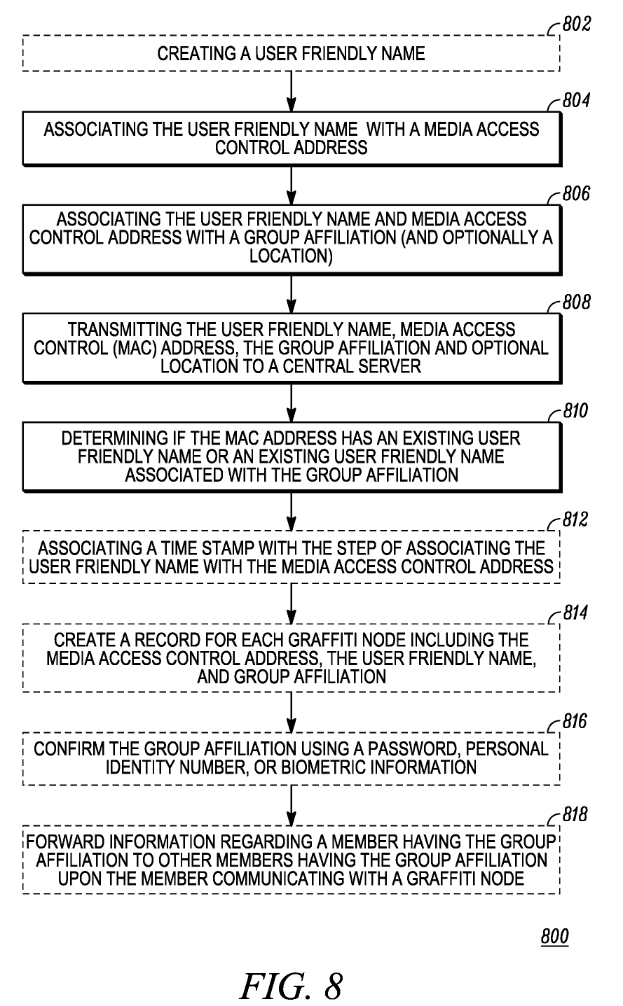

Referring to FIG. 8, a method 800 of forming graffiti nodes in a wireless communication system, can include the optional step 802 of creating a user friendly name, the step 804 of associating a user friendly name with a media access control address, associating the user friendly name and media access control address with a group affiliation and a location at step 806, and transmitting at step 808 the user friendly name, media access control address, the group affiliation and the location to a central server. The method 800 can further include the step 810 of determining if the media access control address has an existing user friendly name or an existing user friendly name associated with the group affiliation. The method 800 can further include the step 812 of associating a time stamp with the step of associating the user friendly name with the media access control address. In this regard, a record for each graffiti node can be created at step 814 including the media access control address, the user friendly name, and the group affiliation. The group affiliation can be confirmed at step 816 using a password, personal identity number, or biometric information. Note, the method 800 can further forward information regarding a member having the group affiliation to other members having the group affiliation upon the member communicating with a graffiti node at step 818.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of forming graffiti nodes in a wireless communication system, comprising the steps of:
associating a user friendly name with a media access control address;
associating the user friendly name and media access control address with a group affiliation; and
transmitting the user friendly name, media access control address, and the group affiliation to a central server.

2. The method of claim 1, wherein the method further comprises the step of determining if the media access control address has an existing user friendly name.

3. The method of claim 1, wherein the method further comprises the step of determining if the media access control address has an existing user friendly name associated with the group affiliation.

4. The method of claim 1, wherein the method further comprises the step of creating the user friendly name.

5. The method of claim 1, wherein the method further comprises the step of associating a time stamp with the step of associating the user friendly name with the media access control address.

6. The method of claim 1, wherein the method further comprises the step of creating a record for each graffiti node containing the media access control address, the user friendly name, the group affiliation.

7. The method of claim 1, wherein the associating with the group affiliation is confirmed using a password, personal identity number, or biometric information

8. The method of claim 1, wherein the method further comprises the step of forwarding information regarding a member having the group affiliation to other members having the group affiliation upon the member communicating with a graffiti node.

9. A mobile wireless device, comprising:
a local area transceiver; and
a processor coupled to the local area transceiver, wherein the processor is programmed to:
associate a user friendly name with a media access control address;
associate the user friendly name and media access control address with a group affiliation; and
transmit the user friendly name, media access control address, and the group affiliation to a central server.

10. The mobile wireless device of claim 9, wherein the processor is further programmed to determine if the media access control address has an existing user friendly name associated with the group affiliation.

11. The mobile wireless device of claim 9, wherein the processor is further programmed to create the user friendly name.

12. The mobile wireless device of claim 9, wherein the processor is further programmed to associate a time stamp with the user friendly name and the media access control address.

13. The mobile wireless device of claim 9, wherein mobile wireless device further comprises a security device coupled to the processor and wherein the processor is further programmed confirm group affiliation by using a password, personal identity number, or biometric information

14. The mobile wireless device of claim 9, wherein the processor is further programmed to forward information regarding a member having the group affiliation to other members having the group affiliation upon the member communicating with a graffiti node.

15. The mobile wireless device of claim 9, wherein the mobile wireless device further comprises a wide area transceiver coupled to the processor.

16. The mobile wireless device of claim 15, wherein the local area transceiver is a Bluetooth transceiver or an IEEE 802.11 based transceiver or a personal area network transceiver or a peer-to-peer transceiver and the wide area transceiver is a cellular phone transceiver, a trunked two-way radio transceiver, a two-way data messaging transceiver, or an IEEE 801.16 based transceiver.

17. A communication system including a plurality of graffiti nodes, comprising:
a plurality of wireless access points forming the graffiti nodes;
a server coupled to the plurality of wireless access points;
a mobile wireless device having at least a local area transceiver; and
a processor operatively coupled to the local area transceiver, wherein the processor is programmed to:
associate a user friendly name with a media access control address;
associate the user friendly name and media access control address with a group affiliation and a location; and
transmit the user friendly name, media access control address, the group affiliation and the location to the server.

18. The communication system of claim 17, wherein the server is further coupled to a central server.

19. The communication system of claim 17, wherein the server stores a record for each graffiti node containing the media access control address, the user friendly name, the group affiliation, a log or list of individuals affiliated with the graffiti nodes, and a log or list of locations where the graffiti nodes were located.

20. The communication system of claim 17, wherein the communication system comprises a plurality of mobile wireless devices and wherein each of the mobile wireless devices within a given group affiliation and the server have synchronized information with respect to the media access control address and the user friendly name.
